(19) United States
(12) Patent Application Publication
(10) Pub. No.: US 2022/0363016 A1
(43) Pub. Date: Nov. 17, 2022

(54) Polymer Composite Layered Structure And Melt Functional Fastener

(71) Applicant: Tundra Composites, LLC, White Bear Lake, MN (US)

(72) Inventor: Kurt Heikkila, Marine on the St. Croix, MN (US)

(73) Assignee: Tundra Composites LLC, White Bear Lake, MN (US)

(21) Appl. No.: 17/709,197

(22) Filed: Mar. 30, 2022

Related U.S. Application Data
(63) Continuation of application No. 16/480,027, filed on Jul. 23, 2019, now abandoned.
(60) Provisional application No. 62/450,189, filed on Jan. 25, 2017.

(51) Int. Cl. B29C 65/56; B29C 65/08; B29C 65/14; B29C 65/18; B29C 65/48; B29C 65/64; B29C 65/00

(52) U.S. Cl. CPC B29C 65/562; B29C 65/08; B29C 65/1412; B29C 65/18; B29C 65/4815; B29C 65/64; B29C 66/21; B29C 66/303; B29C 66/41; B29C 66/472; B29C 66/721; B29C 66/7392; B29C 66/7394; B29C 66/742

(57) ABSTRACT

An article is formed by joining two or more layers in a stable structure, containing at least one composite layer that can be melted, with tensile and shear strength. The article is assembled by one or more mechanical fasteners and melt adhesion regions.

### CROSS REFERENCE TO RELATED APPLICATIONS

This application is a continuation application of application Ser. No. 16/480,027, filed Jul. 23, 2019, which claims priority to National Stage entry PCT/US2018/014973, filed on Jan. 24, 2018, which claims priority from Provisional Patent Application No. 62/450,189, filed Jan. 25, 2017, titled “Polymer Composite Layered Structure And Melt Functional Fastener”. The entire disclosures of all being incorporated herein by reference.

### FIELD

The disclosure relates to an article formed from at least one composite layer a second layer and a fastener. The article has novel and improved shear and tensile modulus characteristics. The novel properties are produced in the composite by novel adhesive interactions of the components that prevent formation of a mechanical failure locus or failure mode.

### BACKGROUND

In typical joinery technology, a fastener joins a first later layer and a second layer. Typically, in such structures, a hole is drilled through both layers and a fastener is installed and fixed in place joining the layers. Commonly a rivet or a clipped fastener is installed. Alternately, threaded fastener is installed by threading the fastener into the hole using typical application equipment and a nut. We have found that typical fastener technology forms insufficiently mechanical stable articles since the creation of the hole prior to the installation of a fastener often results in the creation of a failure mode or failure locus at the hole. This failure mode results from the existence of the drilled hole. The fact that the layers while held in place with a fastener with no other attachment points does not cure the failure mode. A substantial need exists to obtain a mechanically stable article comprising a first layer joined with a second layer using a mechanical fastener that creates a bonded structure without creating a failure mode associated with the introduction of a hole into the structure.

### BRIEF DESCRIPTION

We have found that an article can be manufactured comprising at least a thermoplastic or thermosetting polymer composite material layer and a second layer. The layers are placed in contact and a fastener can be used to penetrate the layers without a drilled hole in the composite. Such penetration occurs because the fastener is heated to a temperature sufficient to cause the composite material to melt adjacent to the fastener and permit the fastener to penetrate the composite material. The molten material from the composite then is available to bind the fastener head and fastener body to the composite. The melt material can bond the layers at the interface of a layer to layer structure. In this way, the fastener is not introduced into a hole that creates a failure mode but creates its own installation location and at the same time creates adhesive bonding and mechanical bonding in the layered structure. As such, the adhesive bonding character of the molten composite prevents the creation of a failure mode/locus in the bonded structure.

Embodiment one is an article formed by joining a composite layer to a second composite layer with a fastener using the methods of the claimed technology.

Embodiment two is an article formed by joining a composite layer to a second non-composite layer with a fastener using the methods of the claimed technology.

Embodiment three is an article formed by joining a composite layer to a metal layer with a fastener using the methods of the claimed technology.

The term “fastener” indicates typically an elongated rigid article having at one end a head with a body extending therefrom, the head having a diameter greater than the body and at the opposite end from the head. The fastener can use means for holding the fastener in place when used. The fastener typically is a metallic structure having sufficient heat conduction such that the fastener will melt any thermoplastic material adhesive or composite that the fastener body contacts during use. The fastener typically has sufficient length to penetrate and extend through two or more layers of a layered structure at a minimum and through multiple layers as needed. The fastener can be used with an anchor placed distal to the head at the exterior of the article

The term “composite” means a solid material comprising a polymeric phase and dispersed in the polymeric phase a discontinuous phase that can comprise a fiber, a particle or a particle mixed with a fiber.

The term “stable” or “mechanically stable” refers to an article that comprises a first layer and a second or three or more layers that are joined by a fastener and the fastener causes both sufficient mechanical and adhesive structural integrity such that the layers do not substantially move with respect to each other in any direction and article will survive any typical use environment.

The term “layer” typically refers to a substantially planar article that has a thickness of 1 to 10 millimeters and typically undefined length and width, in which both is substantially larger than the thickness.

The term “adhesive” or “adhesion” region refers to a structure portion held by a solidified melt formed from the polymer from a layer or from a separate adhesive material.

### BRIEF DISCUSSION OF THE DRAWINGS

FIG. 1A and 1B show the installation of a fastener into an article having a first composite layer and a second composite layer.

FIGS. 2A and 2B show the installation of a fastener into an article comprising a first composite layer and a second metallic layer.

FIG. 3 shows the fastener containing an adhesive layer that can be used in bonding the various layers in the joined article.

FIG. 4 shows the use of the fastener of FIG. 3 in bonding an article comprising a composite layer and a metallic layer with an associated aperture. Lastly,

FIGS. 5A and 5B illustrates the use of the fastener in forming an article from a first composite layer, and a second metallic layer having a preformed aperture but also containing the metal layer aperture such that the metal layer aperture can fill with the molten adhesive molten melt material. Lastly, the fastener is held in place in the article using a clip or other means to fix the fastener in place to prevent easy removal.

### DETAILED DISCUSSION

An article comprises at least a polymer composite material layer, a second layer and optionally three or more layers. The layers are joined in a mechanically stable structure. The structure comprises a fastener penetrating the layers. Melt adhesion region formed by the heat of the fastener join the fastener and the layered structure into a stable unit. Any melt adhesion region derived by melt formation of bonding are derived from heating the polymer composite material layer or by heating a thermoplastic adhesive. The combination of the mechanical fastener and the formation of one or more melt adhesion regions prevent the formation of a failure mode/locus.

### Article

The article can be an assembly of two or more composite layers joined by the fastener in a thermoplastic mechanism. The article can be an assembly of one or more melt capable composite layers often made of thermoplastic materials and composites. The composite layer(s) are joined with one or more of a second layer that is not a composite. The article can have an anchor to aid in its stability.

A preferred article comprises an extension or folding ladder wherein any horizontal member such as one or more steps, are bonded to the vertical rails using the technology as claimed. Other articles that can benefit from the embodiments of the disclosure include railings, fencing, decking, scaffolding etc. with layered structures.

### Fastener

The fastener of the application is typically an elongated article having a material with sufficient heat conduction and capacity such that the heated fastener can melt and penetrate at least one polymer composite layer. The fastener typically comprises a head and elongated body and at the opposite end of the fastener from the head a location such that the fastener can be fixed in place after application. After installation the fastener is held in place by the cooperation of the fastener head and at the opposite end of the elongated body means to hold to the fastener place. The fastener head typically comprises a portion of the fastener comprising a structure with a greater diameter than the diameter of the fastener body. The greater diameter extends past the periphery of the installed fastener body thereby preventing the fastener from passing through the joined layers. The fastener head can include a recessed area within the diameter of the fastener head such that any molten composite material created during installation fills the recess and aids the meld adhesion of the fastener to composite layer. At the opposite end of the fastener is a portion that extends past the exterior surface of any other layer present in the joined article. After the initial installation of the fastener, the end opposite the head can then be treated such that the fastener cannot be removed from the structure by removing the fastener from the head end. The opposite end of the fastener can be an anchor. An anchor is an portion expanded mechanically, such that the fastener material is forced to extend past the diameter of the fastener head. Alternatively, the portion of the fastener that extends past the exterior of the layers can be fixed in place with a separate fixing structure. Such structures include a nut that can be threaded onto a threaded portion of the fastener and, a cotter pin, a c-clamp, a washer that is held in place with an adhesive often thermoplastic, or any other fixing means that can ensure that the fastener body cannot be easily withdrawn from the article. The head can also be installed with a cooperating washer.

Typically, the fastener head and fastener body are cylindrical in shaper but can comprise a variety of shapes. The fastener body can be rectangular or square in cross section, can be hexangular or any other geometric structure such as oval, lobed, etc. Additionally, apart from the cross-sectional shape of the fastener body, the fastener body can be threaded can be grooved or otherwise machined. The threaded aspect of the fastener can aid in the attachment of a nut and installation and further can provide mechanical integrity to the joined structure as the threads interact with the layers joined in the article. Further the grooved structure can provide a path for the molten composite material to flow along the length of the fastener to interact with the layers of the article to further bond the layers together and to bond the layers to the fastener. In certain embodiments, the fastener can be hollow. Such a hollow fastener can be used for the purpose of introducing a heating element to the interior of the fastener to accelerate heating and melting. Further the hollow aspect can act as a conduit for optical electrical or other connections used as such an article and a structural application.

### First Layer Composite

The first layer is a composite layer that can be melted at fastener installation temperatures. The composite material comprises a continuous thermoplastic polymer phase and a discontinuous fiber particle of fiber/particle phase dispersed into the polymer. The composite is made with interfacially modified (interfacial modifier or IM) coated particles or fiber or both. The thermoset or thermoplastic polymers is surprisingly effective to make an article with the fastener and the melt formation of bonding the fastener body or shank of the fastener and layers. Both the polymer and the IM coating on the particles provide adherence or re-adherence to the polymer phase of the composite structure or the structure, such as the shank, of a fastener. IM coated particles enable the composite to retain the underlying rheology of the thermoplastic polymer and its other thermoplastic characteristics such as remelting.

The fiber/particle phase of the composite may be wood, metal, glass, glass bubbles, and/or inorganic material. The particles, and mixtures of particle sizes, may be almost circular with a circularity of from greater than 12.5 to 20 and aspect ratio of 1:3. Particles may also be fibers of wood, metal, and/or inorganic material with aspect ratios of greater than 1:3 such as 1:10, 1:20, 1:30, 1:40, 1:50, 1:60, 1:70, 1:80, 1:90 or 1:100. Interfacially modified particle, fiber or mixed particle and fiber content of the composite may be 30 to 95 vol. %. Thermoplastic polymer content may be 5 to 70 vol. %.

### Polymer

Thermoplastic or thermosetting resins can be used in the disclosure. Such resins are discussed in more detail below. In the case of thermoplastic resins, the composites are specifically formed by blending the particulate and interfacial modifier with thermoplastic and then forming the material into a finished composite. Thermosetting composites are made by combining the particulate and interfacial modifier with an uncured material and then curing the material into a finished composite.

In both cases, the particulate material is typically coated with an interfacial surface chemical treatment that supports or enhancing the final properties of the composite.

A composite is more than a simple admixture. A composite is defined as a combination of two or more substances intermingled with various percentages of composition, in which each component results in a combination of separate materials, resulting in properties that are in addition to or superior to those of its constituents. We believe an interfacial modifier is an organic material that provides an exterior coating on the particulate promoting the close association of polymer and particulate. Minimal amounts of the modifier can be used including about 0.005 to 3 wt.-%, 0.01 to 3 wt. % 0.01 to 4 wt. %, 0.02 to 3 wt. %, 0.02 to 2 wt. % or 0.2 to 1 wt. %.

The interfacial modification technology depends on the ability to isolate the particles or fibers from the continuous polymer phase. The isolation is obtained from a continuous molecular layer(s) of interfacial modifier to be distributed over the surface. Once this layer is applied, the behavior at the interface of the interfacial modifier to polymer dominates and defines the physical properties of the composite and the shaped or structural article (e.g. modulus, tensile, rheology, packing fraction and elongation behavior) while the bulk nature of the fiber dominates the bulk material characteristics of the composite (e.g. density, thermal conductivity, compressive strength). The correlation of fiber bulk properties to that of the final composite is especially strong due to the high-volume percentage loadings of discontinuous phase, such as fiber, associated with the technology.

A large variety of polymer materials can be used in the composite materials of the disclosure. For the purpose of this application, a polymer is a general term covering either a thermoset or a thermoplastic. We have found that polymer materials useful in the disclosure include both condensation polymeric materials and addition or vinyl polymeric materials. Included are both vinyl and condensation polymers, and polymeric alloys thereof. Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation. The polymer has a density of at least 0.85 gm-cm⁻³, however, polymers having a density of greater than 0.96 are useful to enhance overall product density. A density is often up to 1.7 or up to 2 gm-cm⁻³ or can be about 1.5 to 1.95 gm-cm⁻³.

Vinyl polymers include polyethylene, polypropylene, polybutylene, acrylonitrile-butadiene-styrene (ABS), polybutylene copolymers, polyacetal resins, polyacrylic resins, homopolymers or copolymers comprising vinyl chloride, vinylidene chloride, fluorocarbon copolymers, etc. Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials.

Polymer blends or polymer alloys can be useful in manufacturing the pellet or linear extrudate of the disclosure. Such alloys typically comprise two miscible polymers blended to form a uniform composition. Scientific and commercial progress in the area of polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition-weighted average of properties possessed by the components. In general, however, the property dependence on composition varies in a complex way with a particular property, the nature of the components (glassy, rubbery or semi-crystalline), the thermodynamic state of the blend, and its mechanical state whether molecules and phases are oriented.

The primary requirement for the substantially thermoplastic engineering polymer material is that it retains sufficient thermoplastic properties such as viscosity and stability, to permit melt blending with a particulate, permit formation of linear extrudate pellets, and to permit the composition material or pellet to be extruded or injection molded in a thermoplastic process forming the useful product.

A thermosetting resin employs a prepolymer in a soft solid or viscous liquid state that changes irreversibly into an infusible, insoluble polymer network by curing. Curing is induced by the action of heat or suitable radiation often under high pressure, or by mixing with a catalyst or crosslinking agent often under atmospheric conditions at ambient temperature. A cured thermosetting resin is called a thermoset or a thermosetting plastic/polymer when used as the bulk material in a polymer composite, they are referred to as the thermoset polymer matrix. When compounded with fiber they form fiber reinforced polymer composites which are used in the fabrication of factory finished structural composite OEM or replacement parts, and as site-applied, cured and finished composite repair and protection materials. When used as the binder for aggregates and other solid fillers they form particulate reinforced polymer composites which are used for factory-applied protective coating or component manufacture, and for site-applied and cured construction, maintenance, repair or overhaul of industrial engineering materials.

Useful thermosets include acrylic resins, polyesters and vinyl esters with unsaturated sites at the ends or on the backbone are generally linked by copolymerization with unsaturated monomer diluents, with cure initiated by free radicals generated from ionizing radiation or by the photolytic or thermal decomposition of a radical initiator—the intensity of crosslinking is influenced by the degree of backbone unsaturation in the prepolymer; epoxy functional resins can be homopolymers with anionic or cationic catalysts and heat, or copolymerized through nucleophilic addition reactions with multifunctional crosslinking agents which are also known as curing agents or hardeners. As reaction proceeds, larger and larger molecules are formed and highly branched crosslinked structures develop, the rate of cure being influenced by the physical form and functionality of epoxy resins and curing agents—elevated temperature posturing induces secondary crosslinking of backbone hydroxyl functionality which condense to form ether bonds; polyurethanes form when isocyanate resins and prepolymer are combined with low- or high-molecular weight polyols, with strict stoichiometric ratios being essential to control nucleophilic addition polymerization—the degree of crosslinking and resulting physical type (elastomer or plastic) is adjusted from the molecular weight and functionality of isocyanate resins, prepolymer, and the exact combinations of diols, triols and polyols selected; and phenolic, amino and furan resins all cure by polycondensation involving the release of water and heat, with cure initiation and polymerization exothermic control influenced by curing temperature, catalyst selection/loading and processing method/pressure—the degree of pre-polymerization and level of residual hydroxymethyl content in the resins determine the crosslink density.

Preferred are polyester resins that are unsaturated synthetic resins formed by the reaction of dibasic organic acids and polyhydric alcohols. Maleic Anhydride is a commonly used raw material with di-acid functionality. Polyester resins are used in sheet molding compound, bulk molding compound and the toner of laser printers. Panels or layer structures are fabricated from polyester resins reinforced with composite forming materials such as fiberglass—so-called fiberglass reinforced plastic (FRP)—are typically used in restaurants, kitchens, restrooms and other areas that require washable low-maintenance walls. Unsaturated polyesters are condensation polymers formed by the reaction of polyols (also known as polyhydric alcohols), organic compounds with multiple alcohol or hydroxyl functional groups, with saturated or unsaturated dibasic acids. Typical polyols used are glycols such as ethylene glycol; acids used are phthalic acid and maleic acid. Water, a by-product of esterification reactions, is continuously removed, driving the reaction to completion. The use of unsaturated polyesters and additives such as styrene lowers the viscosity of the resin. The initially liquid resin is converted to a solid by cross-linking chains. This is done by creating free radicals at unsaturated bonds, which propagate in a chain reaction to other unsaturated bonds in adjacent molecules, linking them in the process. The initial free radicals are induced by adding a compound that easily decomposes into free radicals. This compound is usually and incorrectly known as the catalyst. Initiator is the more correct term. Substances used are generally organic peroxides such as benzoyl peroxide or methyl ethyl ketone peroxide.

Polyester resins are thermosetting and, as with other resins, cure exothermically. The use of excessive initiator especially with a catalyst present can, therefore, cause charring or even ignition during the curing process. Excessive catalyst may also cause the product to fracture or form a rubbery material.

### Particulate and Fiber

Useful fiber includes both natural and synthetic fibers. Natural fiber includes those of animal or plant origin. Plant based examples include cellulosic materials such as wood fiber, cotton, flax, jute, cellulose acetate etc.; animal-based materials made of protein include wool, silk etc. Synthetic fibers include polymer materials such as acrylic, aramid, amide-imide, nylon, polyolefin, polyester, polyurethane, carbon, etc. Other types include glass, metal, or ceramic fibers. Metallic fibers are manufactured fibers of metal, metal coated plastic or a core completely covered by metal. Non-limiting examples of such metal fibers include gold, silver, aluminum, stainless steel and copper. The metal fibers may be used alone or in combinations. The determinant for the selection metal fiber is dependent on the properties desired in the composite material or the shaped article made therefrom. One useful fiber comprises a glass fiber known by the designations: A, C, D, E, Zero Boron E, ECR, AR, R, S, S-2, N, and the like. Generally, any glass that can be made into fibers either by drawing processes used for making reinforcement fibers or spinning processes used for making thermal insulation fibers. Such fiber is typically used as a length of about 0.8-100 mm often about 2-100 mm, a diameter about 0.8-100 microns and an aspect ratio (length divided by diameter) greater than 90 or about 100 to 1500.

These commercially available fibers are often combined with a sizing coating. Such coatings cause the otherwise ionically neutral glass fibers to form and remain in bundles or fiber aggregates. Sizing coatings are applied during manufacture before gathering. Sizings can be lubricants, protective, or reactive couplers but do not contribute to the properties of a composite using an interfacial modifier coating on the fiber surface. Sizing coatings are not interfacial modifiers.

The inorganic, ceramic or metallic particles typically have a particle size that ranges from about 2 to 500, 2 to 400, 2 to 300, 2 to 200, or 2 to 100 microns, 4 to 300, 4 to 200, or 4 to 100 microns, and often 5 to 250, 5 to 150, 5 to 100, 5 to 75, or 5 to 50 microns. A combination of a larger and a smaller particle wherein there is about 0.1 to 25 wt. % of the smaller particle and about 99.9 to about 75 wt. of larger particles can be used where the ratio of the diameter of the larger particles to the ratio of the smaller is about 2:1, 3:1, 4:1, 5:1, 6:1 or 7:1. In some embodiments there may be three or more components of particle sizes such as 49:7:1 or 343:49:7:1. In other embodiments there may be a continuous gradient of wide particle size distributions to provide higher packing densities or packing fractions. These ratios will provide optimum self-ordering of particles within the polymer phase leading to tunable particle fractions within the composite material. The self-ordering of the particles is improved with the addition of interfacial modifier as a coating on the surface of the particle.

Metals that can be used in powder metal technology include copper metal, iron metal, stainless steel nickel metal, tungsten metal, molybdenum, and metal alloys thereof and bi-metallic particles thereof. Often, such particles have an oxide layer that can interfere with shape formation. The metal particle composition used in particle metallurgy typically includes a large number of particulate size materials. The particles that are acceptable molding grade particulate include particle size, particle size distribution, particle morphology, including reference index and aspect ratio. Further, the flow rate of the particle mass, the green strength of the initial shaped object, the compressibility of the initial shaped object, the removability or eject ability of the shaped object from the mold, and the dimensional stability of the initial shape during processing and later sintering is also important.

Ceramic material that can be used as a particulate includes ceramics that are typically classified into three distinct material categories, including aluminum oxide and zirconium oxide ceramic, metal carbide, metal boride, metal nitride, metal silicide compounds, and ceramic material formed from clay or clay-type sources. Examples of useful technical ceramic materials are selected from barium titanate, boron nitride, lead zirconate or lead tantalite, silicate aluminum oxynitride, silica carbide, silica nitride, magnesium silicate, titanium carbide, zinc oxide, and/or zinc dioxide (zirconia) particularly useful ceramics of use comprise the crystalline ceramics. Other embodiments include the silica aluminum ceramic materials that can be made into useful particulate. Such ceramics are substantially water insoluble and have a particle size that ranges from about 10 to 500 microns, have a density that ranges from about 1.5 to 3 gram/cc and are commercially available. In an embodiment, soda lime glass may be useful. One useful ceramic product is the 3M ceramic microsphere material such as the g-200, g-400, g-600, g-800 and g-850 products.

Minerals include compounds such as Carbide, Nitride, Silicide and Phosphide; Sulphide, Selenide Telluride Arsenide and Bismuthide; Oxysulphide; Sulphosalt, such as Sulpharsenite, Sulphobismuthite, Sulphostannate, Sulphogermanate, Sulpharsenate, Sulphantimonate, Sulphovanadate and Sulphohalide; Oxide and Hydroxide; Halides, such as Fluoride, Chloride, Bromide and Iodide; Fluoroborate and Fluorosilicate; Borate; Carbonate; Nitrate; Silicate; Silicate of Aluminum; Silicate Containing Aluminum or other Metals; Silicates containing other Anions; Niobate and Tantalate; Phosphate; Arsenate such as arsenate with phosphate (without other anions); Vanadate (vanadate with arsenate or phosphate); Phosphates, Arsenates or Vanadate; Arsenite; Antimonate and Antimonite; Sulphate; Sulphate with Halide; Sulphite, Chromate, Molybdate and Tungstate; Selenite, Selenate, Tellurite, and Tellurate; Iodate; Thiocyanate; Oxalate, Citrate, Mellitate and Acetates include the arsenide, antimonide and bismuthide of e.g., metals such as Li, Na, Ca, Ba, Mg, Mn, Al, Ni, Zn, Ti, Fe, Cu, Ag and Au. Garnet, is an important mineral and is a nesosilicate that complies with general formula X₃Y₂(SiO₄)₃. The X is divalent cation, typically Ca²⁺, Mg²⁺, Fe²⁺ etc. and the Y is trivalent cation, typically Al³⁺, Fe³⁺, Cr³⁺, etc. in an octahedral/tetrahedral framework with [SiO₄]⁻ occupying the tetrahedral structure. Garnets are most often found in the dodecahedral form, less often in trapezo-hedral form.

One particularly useful inorganic material used are metal oxide materials including aluminum oxide or zirconium oxide. Aluminum oxide can be in an amorphous or crystalline form. Aluminum oxide is typically formed from sodium hydroxide, and aluminum ore. Aluminum oxide has a density that is about 3.8 to 4 g-cc and can be obtained in a variety of particle sizes that fall generally in the range of about 10 to 1,000 microns.

Zirconium oxide is also a useful ceramic or inorganic material. Zirconium dioxide is crystalline and contains other oxide phases such as magnesium oxide, calcium oxide or cerium oxide. Zirconium oxide has a density of about 5.8 to 6 gm-cm⁻³ and is available in a variety of particle sizes. Another useful inorganic material concludes zirconium silicate. Zirconium silicate (ZrSiO₄) is an inorganic material of low toxicity that can be used as refractory materials. Zirconium dioxide has a density that ranges from about 4 to 5 gm/cc and is also available in a variety of particulate forms and sizes.

One important inorganic material that can be used as a particulate in another embodiment includes silica, silicon dioxide (SiO₂). Silica is commonly found as sand or as quartz crystalline materials. Also, silica is the major component of the cell walls of diatoms commonly obtained as diatomaceous earth. Silica, in the form of fused silica or glass, has fused silica or silica line-glass as fumed silica, as diatomaceous earth or other forms of silica as a material density of about 2.7 gm-cm⁻³ but a particulate density that ranges from about 1.5 to 2 gm-cm⁻³.

Glass spheres (including both hollow and solid) are another useful non-metal or inorganic particulate. These spheres are strong enough to avoid being crushed or broken during further processing, such as by high pressure spraying, kneading, extrusion or injection molding. In many cases these spheres have particle sizes close to the sizes of other particulate if mixed together as one material. Thus, they distribute evenly, homogeneously, within the composite upon introduction and mixing. The method of expanding solid glass particles into hollow glass spheres by heating is well known. See, e.g., U.S. Pat. No. 3,365,315 herein incorporated by reference in its entirety. Useful hollow glass spheres having average densities of about 0.1 grams-cm⁻³ to approximately 0.7 grams-cm⁻³ or about 0.125 grams-cm⁻³ to approximately 0.6 grams-cm⁻³ are prepared by heating solid glass particles.

### Second Layer

The second layer can be any layer comprising a composite, a thermoplastic, a thermoset, wood, metal or other structural material. A preferred second layer comprises aluminum, magnesium, or other lightweight metal or alloy. In the instance that the second layer cannot be melted at the installation temperature of the fastener, the layer must have an aperture formed in the layer to receive that fastener and pass the fastener through the layer. Such an aperture is preferable sized to have a diameter matching the diameter of the fastener. During assembly, the fastener is positioned such that the fastener body penetrates the composite and then extends into the aperture of the second layer. If sized as described the melt composite fills any voids in the assembly of fastener and layers to result in a stable bonded structure. The fastener can be fixed in place by a mechanical piece or the fastener end can be expanded to hold it in place.

### Method

The fastener of the disclosure preferably has sufficient heat capacity and conduction such that it can readily heated by a heating element. The fastener should also have tensile flexural and torsional modulus such that it can survive in typical use environments for the article in its typical use applications. Accordingly, metallic fasteners made from aluminum, aluminum alloys, iron, stainless steel or other alloys are preferred.

In certain applications, where the layer of thickness and the fastener geometry produces insufficient amounts of molten flow from the composite to fully bond a fastener to the layers and to bond the layers to adjacent layers, additional adhesive can be used in forming the joint. Such adhesives can be applied to the layers prior to the introduction of the fastener to the layers. Alternatively, the adhesive can be applied to the fastener before introduction of the fastener into the layered structure. As such a layer of adhesive that is less than 1-millimeter-thick and can be applied to the fastener body. The adhesive can also be applied to the fastener head or to both the fastener head and to the fastener body. The fastener body can be covered entirely by the hot melted adhesive or the fastener body can comprise from about 5% to about 90% of the surface area of the fastener body. The adhesive can also comprise about 25 to 75%, 40 to 60% of the fastener body. The adhesive can be applied in a variety patterns onto the fastener body. The adhesive can be applied in stripes, dots or cylindrical applications.

In the installation of the fastener into the layered structured, the fastener is typically heated prior to introducing the fastener into the structure. The fastener has to be heated to a sufficient temperature such that the composite layer will melt to prevent the fastener penetrating at least one layer. Any suitable heating source or method can be used to heat the fastener. Common heating modes can be derived from radio frequency sources, ultrasonic heating sources or conventional infrared heaters including electric heaters, etc.

Once heated to a sufficient temperature, the introduction of the fastener onto the composite layer will cause a melting at the contact point between the heated fastener body and the surface and body of the composite. Through the application of sufficient heating and pressure, the fastener will continue to penetrate the composite body creating additional molten polymer until the fastener penetrates the layer entirely. In the embodiment such that there are two or more thermoplastic or two or more composite layers, the fastener will be configured such that the fastener has sufficient length to penetrate one, two, three, four or more layers with sufficient fastener length to fully penetrate and extend past the surface of the final layer.

In the embodiment one or more composite layers are combined with one or more second (e.g.) metallic layers, typically the metal layers obtain an aperture of sufficient diameter such that once the fastener has penetrated the composite layers that the fastener can penetrate the one or more metallic layers simply by passing through the aperture formed in the layers with a diameter that is substantially the same as the diameter of the fastener. As the fastener penetrates the composite layer, the fastener will distribute molten composite material in association with the fastener, which can be transported from the composite layer into the metal layers. In the one or more composite layers and in the one or more metallic layers, the molten composite material can form bonds between composite layers, between composite layers and metal layers and between the fastener and either the composite layer or the metallic layer thus preventing the formation of failure mode in the assembled article.

In an embodiment the composite material is made with a mixture of IM coated fiber or particles comprising 30 to 95 vol. %, 30 to 85 vol. %, 30 to 75 vol. %, or 30 to 65 vol. % fiber or particles and 70 to 5 vol. %, 70 to 15 vol. %, 70 to 25 vol. %, or 70 to 35 vol. % polymer. The fastener to be inserted through the composite material is attached to an energy source, such as thermal, R_{f} energy, or ultrasonic energy, that can melt the composite material. The supplied energy provides a means to insert the fastener through the composite material structure by melting the thermoplastic polymer phase of the composite material to form a ring around the perimeter of the fastener. After melting, the polymer cools thereby re-hardening the thermoplastic polymer in the polymer phase of the composite. The composite material of the structure and the body of the fastener becomes substantially attached to each other. If more adherence is needed, because of the application or structure for which the composite material is used, additional hot melt adhesive or composite material may be supplied to supplement the material formed during the fastener insertion and melting processes.

Any adhesive that can maintain an adequate mechanically sufficient bond to insure a stable installation of the fastener can be used in addition to the melt adhesion mode. Both hot melt and thermoset adhesives can be used with the required flexibility in the shear mode.

A pressure-sensitive adhesive comprises a layer of a pressure-sensitive adhesive formed on the fastener body. Permanent pressure-sensitive adhesives are adhesives which have a level of adhesion which does not allow the removal from the substrate to which it has been applied without considerable damage the adhesive or the installation. The adhesion of removable pressure-sensitive adhesives is considerably lower, allowing removal of the siding member without damage to adhesive or member even after a protracted period.

In order to retain removable pressure-sensitive properties, it is necessary to limit the relative amount of permanent pressure-sensitive adhesive employed. For a typical application total pressure-sensitive adhesive weight less than about of 20 g-m⁻².

The pressure-sensitive adhesives employed in the installation may be any hot melt, emulsion, pressure-sensitive adhesives that can form a mechanically stable bond between the support and siding member. In order to obtain the desired thermal properties of the finished installation the adhesive must display sufficient bond strength to maintain the siding in place but still retain sufficient viscoelastic nature to permit the siding member to expand and contract with changing temperatures.

### DETAILED DESCRIPTION OF THE DRAWINGS

The claimed structures are illustrated by the following Figures. The particular examples, materials, amounts, and procedures are to be interpreted broadly in accordance with the scope and spirit of the disclosure as set forth herein. The disclosure may be more completely understood in consideration of the following detailed description of various embodiments of the disclosure in connection with the accompanying drawings. An embodiment of the siding system of this disclosure is represented in the following figures, which should not be used as limiting to the scope of the claims.

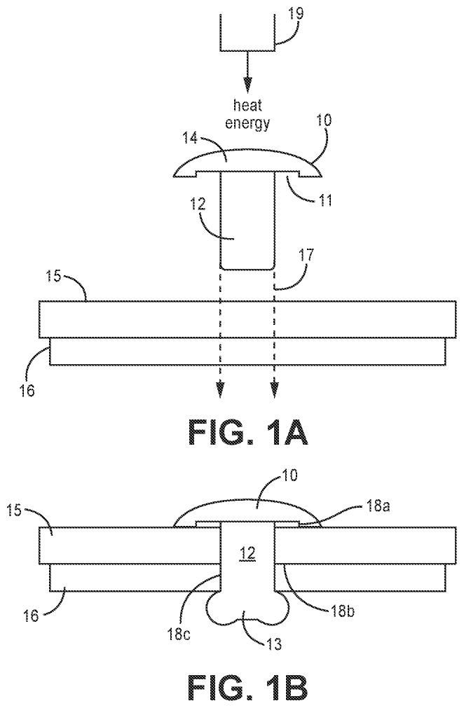

FIG. 1A and 1B shows a cross-sectional view of the association of a fastener 10 with the first composite layer 15 and second composite layer 16. The fastener comprises a fastener head 14, a melt recess zone 11, a fastener body 12. The fastener 10 after installation is mechanically compressed to form expanded end 13 which holds the fastener in place and prevents fastener removal.

FIG. 1B shows a cross section of the fastener 10 installed in the structure after using heat energy 19. The expanded end 13 of the fastener 10 holds the fastener in place and prevents removal. The structure is made mechanically stable in the absence of a failure mode or weak point by the use of the melt adhesion region 18a that bond the head 14 to composite 14, the melt adhesion region 18a that bond the fastener body 12 to the composite 14, the melt adhesion region 18b that bond the layers 15 and 16 and the melt adhesion region 18c that bond the fastener body 12 to the second layer 16.

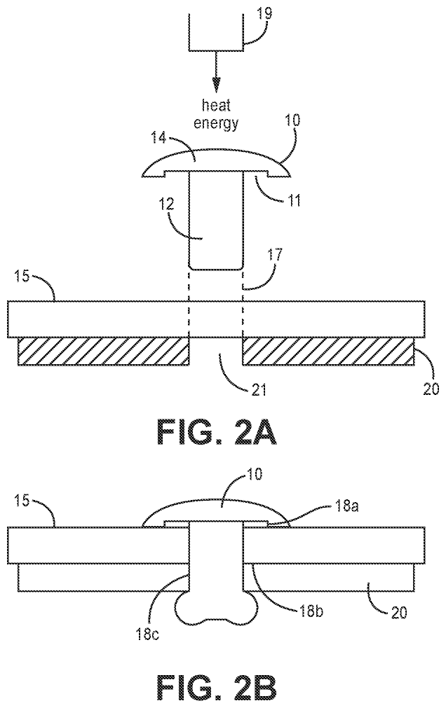

FIG. 2A is a cross-sectional view of the installation of the fastener 10 into a layer of composite 15 and a second layer of metal 20 containing a fastener configured aperture 21. Fastener 10 similarly has a melt recess zone 11, a fastener body 12 and a fastener head 14. In the application of the fastener to the layers as shown, the fastener 10 is heated by an external source of heat energy 19 that is sufficiently heated to melt penetrate the composite layer and extend through the metal layer aperture 21 of the metal layer 20. FIG. 2B shows the fastener in place, the end of the fastener opposite the head can be mechanically compressed to expand the end to fix the fastener in place. Once in place, the heat of the fastener forms melt composite that again causes the melt adhesive to bond the head to the composite in a melt adhesion region 18, bond the fastener to the composite in a melt adhesion region 18a, bond the fastener to the metal layer 20 and the fastener to the composite 18c.

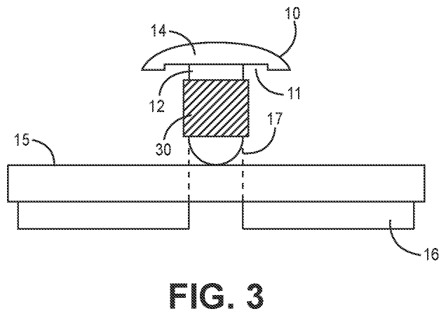

FIG. 3 shows a side view of the fastener of the disclosure adjacent to a layered structure. The fastener 10 comprises a melt recess zone 11, a fastener body 12 and a cylindrical portion of the hot meld adhesive 30 applied to the fastener body 12. During installation, the hot melt adhesive 30 can cooperate with the composite to form the mechanically stable article from the fastener and the first and second layers of the structure.

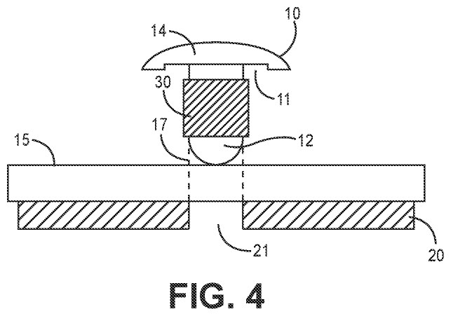

FIG. 4 shows a side view of the fastener of the disclosure adjacent to a layered article comprising a composite layer 15 and a metallic layer 16 with a preformed metal layer fastener aperture 21. The fastener has a cylindrical application of adhesive 30 that can cooperate with the molten composite to form an article that is mechanically stable by the bonding layers and the fastener together with a combination of melt composite entities of material. The melt penetration direction 17 is shown in the dashed lines.

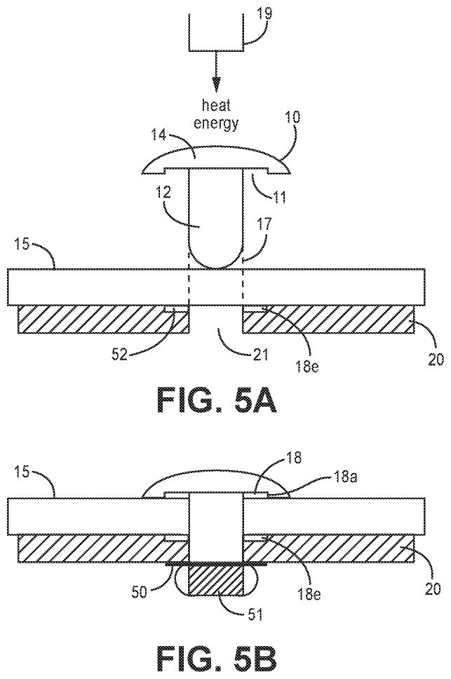

FIGS. 5A and 5B shows a cross-sectional view of an association of a fastener as disclosed with a composite and metal layer structure. The fastener 10 comprises a melt recess zone 11, a fastener body 12 and a fastener head 14. They composite layer 15 the metal layer 20 comprises a preformed fastener aperture 21 and a preformed metal layer recess of 52. Upon application of heat energy to the fastener 10, the fastener penetrates the composite layer thermally and forms melt adhesive bonds between the fastener head using the melt recess zone 11 forming the bond in a melt adhesion region 18. Further bond in a melt adhesion region 18a is formed between the fastener body and the composite layer. Lastly, bonding is formed between the composite layer and the metal layer using the metal layer recess 52 filled by melt 18e of the composite in the recess 52.

FIG. 5B shows a clip 50 that is inserted into a recess of the extended fastener body 51 to hold the fastener in place to form a mechanically sound joint and prevent fastener removal/withdrawal.

Figure Numbering

| Article Structure | Numerical | Article Structure | Numerical |
|---|---|---|---|
| Aspect | Designation | Aspect | Designation |
| Fastener | 10 | Metal layer | 21 |
| | | fastener aperture | |
| Melt recess zone | 11 | Hot melt adhesive | 30 |
| | | layer | |
| Fastener Body | 12 | Fastener clip | 50 |
| Expanded end | 13 | Extended body | 51 |
| Fastener head | 14 | Heat energy | 19 |
| First Composite layer | 15 | Metal layer | 20 |
| Second Composite | 16 | Recess | 52 |
| layer | | | |
| Melt penetration | 17 | | |
| direction | | | |
| Melt Adhesive | 18a | | |
| Region Joint/fastener | | | |
| body to composite | | | |
| Melt Adhesive | 18b | | |
| Region Joint/first | | | |
| composite to second | | | |
| composite | | | |
| Melt Adhesive | 18c | | |
| Region Joint/Fastener | | | |
| body to second | | | |
| composite | | | |
| Metal layer recess for | 18e | | |
| melt | | | |

Procedures and compositions for making the thermoplastic polymer composite material with interfacially modified particles and/or interfacially modified fibers are published in the following patent publications and patent applications: US 2016-0002468—“POLYMER COMPOSITE COMPRISING AN INTERFACIALLY MODIFIED FIBER AND PARTICLE”, patent publication U.S. Pat. No. 9,512,544—“SURFACE MODIFIED PARTICULATE AND SINTERED OR INJECTION MOLDED PRODUCTS”, U.S. Pat. No. 8,487,034 “MELT MOLDING POLYMER COMPOSITE AND METHOD OF MAKING AND USING THE SAME”, U.S. Pat. No. 8,841,358 “Ceramic Composite”, U.S. Pat. No. 9,249,283 “REDUCED DENSITY GLASS BUBBLE POLYMER COMPOSITE” and U.S. patent application Ser. No. 15/348,249 “FIBER POLYMER COMPOSITE”. These patent publications and patent applications are incorporated by reference in their entirety into this application. The composite materials disclosed in these patent publications and patent applications show the advantages of IM coated particles and fibers in the formation of the composite material.

The complete disclosure of all patents, patent applications, and publications cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not to be limited to the exact details shown and described, for variations obvious to one skilled in the art will be included within the disclosure defined by the claims.

The figures are not necessarily to scale. Like numbers used in the figures refer to like components. However, it will be understood that the use of a number to refer to a component in a given figure is not intended to limit the component in another figure labeled with the same number.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the term “or” is generally employed in its inclusive sense including “and/or” unless the content clearly dictates otherwise.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

The terms “comprise and comprises” and variations thereof do not have a limiting meaning where these terms appear in the description and claims.

“Include,” “including,” or like terms means encompassing but not limited to, that is, including and not exclusive.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

While the above specification shows an enabling disclosure of the composite technology of the disclosure, other embodiments may be made without departing from the spirit and scope of the claimed technology. Accordingly, the disclosed technology is embodied in the claims hereinafter appended. While the above specification shows an enabling disclosure of the composite technology of the system, other embodiments of the system components may be made without departing from the spirit and scope of the claimed subject matter.

1-50. (canceled)

51. A structural article comprising a first composite layer and a second composite layer, each composite layer free of metal fiber and comprising 5 to 70 vol. % to of a polyvinyl chloride polymer and 30 to 95 vol. % of a glass fiber having a diameter of 0.8 to 100 microns and an aspect ratio of greater than 90, the structure comprising a metallic fastener comprising a heat conducting material, the fastener penetrating the layers under conditions of temperature and pressure applied to the fastener; wherein the article is stabilized by a melt adhesion region bonding the composite layers, the melt adhesion region is derived from the composite layers.

52. The article of claim 51 wherein the melt adhesion region also has an adhesive.

53. The article of claim 51 wherein the glass fiber has an exterior coating comprising 0.01 to 4 wt. % of an interfacial modifier.

54. The article of claim 51 wherein the metallic fastener comprises aluminum.

55. The article of claim 51 wherein the metal layer comprises aluminum.

56. The article of claim 51 wherein the article comprises a ladder.

57. A method of making a structural article comprising a first composite layer and a second composite layer, each composite layer free of metal fiber comprising 5 to 70 vol. % to of a polyvinyl chloride polymer and 30 to 95 vol. % of a glass fiber having a diameter of 0.8 to 100 microns and an aspect ratio of greater than 90, the method comprising the steps of: forming a layered structure of the composite layers to form a layered structure, contacting the layered structure with a metallic fastener component under conditions of temperature and pressure such that the fastener penetrates both layers and melts sufficient composite material to form at least one melt adhesion region that joins the fastener and the first layer and second layer into a mechanically stable structure.

58. The method of claim 57 wherein the melt adhesion region also has an adhesive.

59. The method of claim 57 wherein the glass fiber has an exterior coating comprising 0.01 to 4 wt. % of an interfacial modifier.

60. The method of claim 57 wherein the metallic fastener comprises aluminum.

61. The method of claim 57 wherein the metal layer comprises aluminum.

62. The method of claim 57 wherein the article comprises a ladder.
